(19) United States
(12) Patent Application Publication
(10) Pub. No.: US 2004/0028174 A1
(43) Pub. Date: Feb. 12, 2004

(54) Distributed and redundant computed radiography systems and methods

(76) Inventor: Jacob Koren, Haifi (IL)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/447,733

(22) Filed: May 29, 2003

Related U.S. Application Data
(60) Provisional application No. 60/385,294, filed on May 31, 2002.
(60) Provisional application No. 60/400,017, filed on Jul. 30, 2002.
(60) Provisional application No. 60/400,301, filed on Jul. 31, 2002.

(51) Int. Cl. G06F 17/60; G21K 1/12; H05G 1/60; G01N 23/00

(52) U.S. Cl. 378/4; 705/2; 382/305

(57) ABSTRACT

In one example, distributed computed radiography (CR) systems are disclosed, in which individual networked CR systems are deployed in different doctors' offices, clinics, and the like, or different rooms of a radiography center, such as that found in a radiology department of a medical facility. The individual networked CR systems may be deployed conveniently near to radiation exposure apparatus, so as to facilitate the overall process of patient exposure and image acquisition/processing. Images acquired from different networked CR systems may be transported to other systems coupled to the distributed CR network, and/or archiving facilities, for processing, storage, cataloging, analysis, etc. In another example, redundant computed radiography systems are disclosed, including multiple independently controllable scanners coupled to a single controller/processor at a given location. Such redundant systems improve image scanning/acquisition throughput and system robustness.

### CROSS REFERENCES TO RELATED APPLICATIONS

The present application claims the benefit, under 35 U.S.C. §119(e), of the following U.S. Provisional Applications, each of which is incorporated herein by reference:

Serial No. 60/385,294, filed May 31, 2002, entitled “Distributed Computed Radiography Systems and Methods;

Serial No. 60/400,017, filed Jul. 30, 2002, entitled “Distributed and Redundant Computed Radiography Systems and Methods; and

Serial No. 60/400,301, filed Jul. 31, 2002, entitled “Distributed and Redundant Computed Radiography Systems and Methods.

### FIELD OF THE INVENTION

The present invention relates generally to methods and apparatus for acquiring and processing X-ray images using computed radiography techniques.

### BACKGROUND

Conventional radiography centers (e.g., as found in radiology departments in medical facilities) may include multiple radiography rooms each equipped with X-ray systems for exposing patients and image recording media (e.g., films) to radiation, so as to acquire X-ray images of patients. Often, an exposed film is loaded into a holder or cassette for transporting the exposed film from the room with the X-ray exposure system to a central processing center. For example, a cassette holding the exposed film typically is hand-carried from the exposure area to a central chemical processing station associated with a main darkroom for developing the exposed film.

This general concept of workflow (i.e., radiation exposure in radiography rooms, and central processing elsewhere) typically dictates the architectural design of the X-ray room layout of a conventional radiography processing center (e.g., in a medical facility). In particular, in a typical layout, a patient corridor may be located in front of a row of X-ray exposure rooms, and a staff corridor may be located behind the row of X-ray exposure rooms, thereby enabling separate traffic flows of patients being imaged and technicians carrying the X-ray cassettes to a central processing area (e.g., main darkroom).

In recent years, digital techniques have been employed in connection with radiography. An early digital solution for radiography processing centers included computed radiography (CR) techniques, which employ erasable phosphor plate recording media. In particular, radiography processing centers began adapting picture archiving and communications systems (PACS) involving computers and digital networks to acquire, archive, and transport computerized radiography images from a central processing center to, for example, doctors and other professionals who would analyze the images. CR systems for such purposes initially were developed and manufactured by the same film producing companies (e.g., Fuji, AGFA, KODAK and KONICA) that were familiar with the workflow and general layout of a conventional centralized radiography film processing center. Therefore, it was natural for these companies to copy the same is workflow concept when employing digital techniques; hence, these manufactures produce CR systems that are essentially replacements or retrofits for the centralized processing stations typically associated with the conventional radiography processing center (i.e., located separately from X-ray exposure areas).

In particular, a conventional main frame CR system is designed to be located in place of the large film processing machine typically found in such a centralized processing station, to receive all of the cassette throughput/flow of the various X-ray exposure rooms of the radiography center. To prevent a “bottleneck” or backlog of film processing, such a system needs to have a high throughput to handle a significant flow of cassettes from many sources without causing any delays. This requirement generally dictates the CR system structure and performance.

For example, conventional main frame CR systems typically include cassette loading stations with multiple insertion slots to accept the flow of cassettes. In such a process, the system typically needs to identify a given cassette by, for example, identifying the imaged patient's name and other relevant information. This information in turn is attached to an image file created by the system during a scan of the image recorded on the phosphor plate recording medium held by the cassette. To facilitate this task, the cassette may include means to carry the patient identification information (e.g., memory chips), as well as means to write the information into the cassette's memory. Typically, after the CR system has pulled the phosphor plate out of the cassette so that it can be scanned, the patient ID information is read from the cassette, and the cassette's memory then is erased to prepare for subsequent reuse.

Once removed from the cassette, the phosphor plate recording medium is transferred by the CR system to a scanning or reading area of the system, and then subsequently to an erasing area to erase the plate and prepare it for subsequent exposures. Following the erasing, the plate is conveyed back to the cassette area to be reloaded into the cassette. Since the foregoing procedure occurs for each of several cassettes at any given time, the procedure typically may be quite complex, as there may be different plate and cassette sizes to be processed by the system. Accordingly, the various steps of the procedure outlined above generally require some manner of synchronization to keep track of a matched cassette/plate pair.

From the foregoing, it should be appreciated that such conventional centralized CR systems typically are complex, expensive, and occupy a significant space in the overall structure of the centralized radiology processing center.

### SUMMARY

One embodiment of the invention is directed to an apparatus in a first computed radiography (CR) system including at least one radiation scanning apparatus configured to acquire first images from exposed image recording media. The apparatus comprises at least one first controller configured to facilitate at least one of transmitting first information relating to the acquired first images to at least one second CR system and receiving second information relating to second images acquired by the at least one second CR system.

Another embodiment of the invention is directed to an apparatus in a first computed radiography (CR) system including at least one radiation scanning apparatus configured to acquire first images from exposed image recording media. The apparatus comprises at least one first controller configured to transmit first information relating to the acquired first images to at least one archive, the at least one archive being configured to receive second information relating to second images acquired by at least one second CR system.

Another embodiment of the invention is directed to a method in a first computed radiography (CR) system in which first images are acquired from exposed image recording media. The method comprises an act of transmitting first information relating to the acquired first images to at least one second CR system.

Another embodiment of the invention is directed to a method in a first computed radiography (CR) system in which first images are acquired from exposed image recording media and first information is obtained relating to the first acquired images. The method comprises an act of receiving second information relating to second images acquired by at least one second CR system.

Another embodiment of the invention is directed to a method in a first computed radiography (CR) system in which first images are acquired from exposed image recording media. The method comprises an act of transmitting first information relating to the acquired first images to at least one archive, the at least one archive being configured to receive second information relating to second images acquired by at least one second CR system.

Another embodiment of the invention is directed to at least one computer readable medium having computer-readable signals stored thereon that define instructions which, as a result of being executed by at least one processor, instruct the at least one processor to perform a method in a first computed radiography (CR) system in which first images are acquired from exposed image recording media. The method comprises an act of transmitting first information relating to the acquired first images to at least one second CR system.

Another embodiment of the invention is directed to at least one computer readable medium having computer-readable signals stored thereon that define instructions which, as a result of being executed by at least one processor, instruct the at least one processor to perform a method in a first computed radiography (CR) system in which first images are acquired from exposed image recording media. The method comprises an act of receiving second information relating to second images acquired by at least one second CR system.

Another embodiment of the invention is directed to at least one computer readable medium having computer-readable signals stored thereon that define instructions which, as a result of being executed by at least one processor, instruct the at least one processor to perform a method in a first computed radiography (CR) system in which first images are acquired from exposed image recording media. The method comprises an act of transmitting first information relating to the acquired first images to at least one archive, the at least one archive being configured to receive second information relating to second images acquired by at least one second CR system.

Another embodiment of the invention is directed to a distributed computed radiography (CR) system, comprising a first CR system, and at least one second CR system coupled to the first CR system via a network. Each CR system comprises at least one controller coupled to the network, and at least one radiation scanning apparatus coupled to the at least one controller and configured to acquire images from exposed image recording media.

Another embodiment of the invention is directed to a radiography method, comprising acts of acquiring first image data at a first location, transporting the acquired first image data from the first location to an archive, acquiring second image data at a second location different from the first location, and transporting the acquired second image data from the second location to the archive.

Another embodiment of the invention is directed to a radiology department of a medical facility, comprising a first radiation exposure area including a first control area, the first control area including at least one first PC-based computed radiography (CR) system configured to scan and acquire images from image recording media that are exposed in the first radiation exposure area, and a second radiation exposure area including a second control area, the second control area including at least one second PC-based CR system configured to scan and acquire images from image recording media that are exposed in the second radiation exposure area, wherein the at least one first PC-based CR system and the at least one second PC-based CR system are coupled to a same network.

Another embodiment of the invention is directed to a radiography method in a radiology department of a medical facility, comprising acts of reading at least one first exposed image recording medium in a first area of the radiology department to acquire first image data, transporting the acquired first image data from the first area to an archive, reading a second exposed image recording medium in a second area of the radiology department different from the first area to acquire second image data, and transporting the acquired second image data from the second area to the archive.

Another embodiment of the invention is directed to a computed radiography (CR) system, comprising at least two radiation scanning apparatus configured to acquire images from exposed image recording media, and a controller coupled to the at least two radiation scanning apparatus and configured to control the at least two radiation scanning apparatus so as to acquire the images from the exposed image recording media.

Another embodiment of the invention is directed to an emergency room of a medical facility, comprising a first radiation exposure area including a first control area, the first control area including at least one PC-based computed radiography (CR) system configured to scan and acquire images from image recording media that are exposed in the first radiation exposure area. The at least one PC-based CR system includes at least two radiation scanning apparatus configured to acquire the images from the exposed image recording media, and a controller coupled to the at least two radiation scanning apparatus and configured to control the at least two radiation scanning apparatus so as to acquire the images from the exposed image recording media.

Another embodiment of the invention is directed to a radiography method, comprising acts of acquiring first image data at a first location using a first device, acquiring at least second image data at the first location using at least one second device, and transporting the acquired first image data and at least the second image data from the respective first and second devices to a same data processor.

Another embodiment of the invention is directed to a radiography control method, comprising an act of controlling at least two radiation scanning apparatus configured to acquire images from exposed image recording media using a single controller.

Another embodiment of the invention is directed to at least one computer readable medium having computer-readable signals stored thereon that define instructions which, as a result of being executed by a single computer, instruct the single computer to perform a radiography control method comprising an act of controlling at least two radiation scanning apparatus configured to acquire images from exposed image recording media using the single computer.

It should be appreciated the all combinations of the foregoing concepts and additional concepts discussed in greater detail below are contemplated as being part of the inventive subject matter disclosed herein. In particular, all combinations of claimed subject matter appearing at the end of this disclosure are contemplated as being part of the inventive subject matter.

### BRIEF DESCRIPTION OF THE DRAWINGS

FIG. 1 illustrates a distributed computed radiography (CR) system according to one embodiment of the invention;

FIG. 2 illustrates a portion of an exemplary radiology department of a medical facility, according to one embodiment of the invention;

FIG. 2A illustrates a distributed CR system according to another embodiment of the invention;

FIG. 3 illustrates a redundant computed radiography (CR) system according to one embodiment of the invention;

FIG. 4 illustrates an exemplary graphic user interface (GUI) of the redundant CR system of FIG. 3, according to one embodiment of the invention; and

FIG. 5 illustrates an exemplary set-up panel associated with the GUI of FIG. 4, according to one embodiment of the invention.

### DETAILED DESCRIPTION

Applicants have recognized and appreciated that alternative CR techniques may be implemented successfully on a smaller scale and/or in a more distributed manner than that generally employed in the conventional centralized radiography processing centers typically found in larger medical facilities.

Accordingly, Applicants have developed a high image quality, compact CR system based on a desktop/personal computer (e.g., PC) system model. Such CR image acquisition systems generally are significantly smaller in size than the conventional main frame systems described above, and in some cases handle fewer cassettes in a given time period. Nonetheless, from an imaging point of view, these systems have similar image-rendering performance capabilities as the larger main frame systems, and are capable of conveniently providing digital computed radiography techniques for a variety of environments (large medical facilities, smaller facilities providing medical and dental services such as doctors' offices, various local clinics, etc.). For example, Applicants have developed medical, dental and orthodontic products directed to PC-based CR systems for acquiring (e.g., scanning), analyzing, and cataloging X-ray images stored on photo-stimulating-phosphor (PSP) plates.

One exemplary implementation of such PC-based CR systems includes a CR scanner having a mounting mechanism that is adapted to carry one or more PSP plates of various sizes. The CR scanner also includes a radiation scanning apparatus for irradiating the one or more PSP plates mounted on the drum. In particular, the radiation scanning apparatus includes a radiation source (e.g., a laser) that is operated to generate a radiation beam which scans the PSP plate(s). The scanning apparatus also is adapted to detect the radiation reflected from one or more PSP plates, so as to acquire copies of the X-ray images stored on the plate(s).

Via the control of a desktop/personal computer or “PC” coupled to the CR scanner, the scanning apparatus transfers the images stored on the PSP plate(s) to an appropriate digital computer format based on the radiation reflected from the plate(s). Once transferred to such a format, the images may be stored at one or more memory locations (e.g., on the PC) and manipulated by a user for various screening, archiving, and analytical purposes. The acquired images also may be transmitted to various locations (e.g., other dental/orthodontic practitioners, medical insurance companies, etc.) via any conventional communications means (e.g., telephone lines, network connections, etc.). Additionally, the PC-based CR system may be configured such that the PSP plate(s) may be erased automatically after the images have been scanned and acquired, so that the plate(s) may be reused. Other details of various features and exemplary implementations of such systems are described, for example, in U.S. Pat. No. 6,291,831, U.S. Pat. No. 6,207,968, U.S. Pat. No. 6,315,444, and U.S. patent application Ser. No. 09/928,291 (Publication No. US 2002/0003219 A1), each of which patents are hereby incorporated herein by reference.

Following below are more detailed descriptions of various concepts related to, and embodiments of, methods and apparatus according to the present invention. It should be appreciated that various aspects of the invention, as discussed above and outlined further below, may be implemented in any of numerous ways, as the invention is not limited to any particular manner of implementation. Examples of specific implementations are provided herein for illustrative purposes only.

Distributed CR Systems and Methods

Applicants also have recognized and appreciated that a number of PC-based CR systems as discussed above, and more generally a number of CR scanning apparatus accessible via one or more user interfaces, may be coupled together in the form of a distributed CR network. Such a distributed CR network may be implemented in various environments to provide a powerful radiography image acquisition and processing tool. Accordingly, one embodiment of the present invention is directed to distributed CR systems and methods that may be implemented, for example, as an alternative to, or as a replacement for, centralized main frame CR system approaches conventionally employed in radiography processing centers such as radiology departments in large medical facilities. It should be appreciated, however, that in various aspects, distributed CR systems and methods according to the invention are not limited to application in such environments, as a number of implementations of distributed CR systems according to the invention are possible according to different applications and environments.

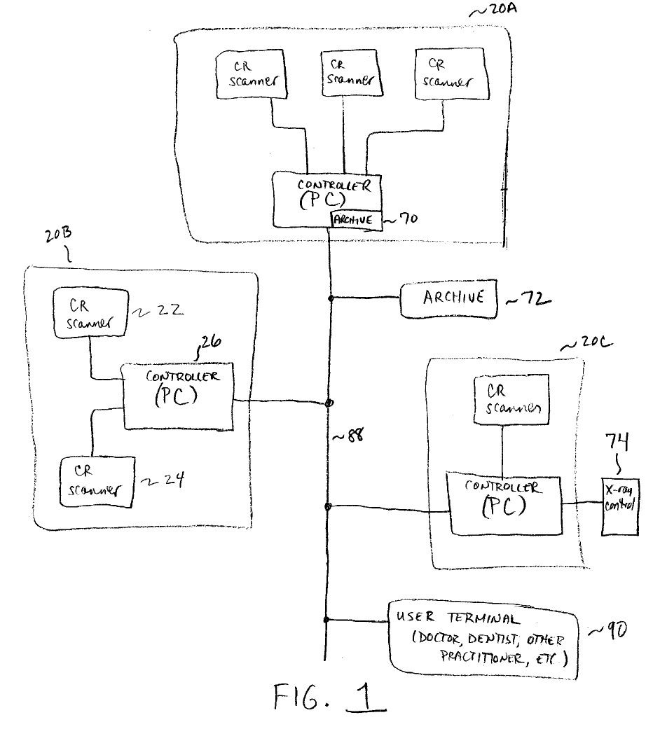

For example, according to one embodiment of the invention, as shown in FIG. 1, a plurality of CR systems 20A, 20B, and 20C dispersed amongst a number of different locations may be coupled together via a network connection 88 to form a network so as to share imaging and archiving resources. For purposes of the present disclosure, a “network” refers to any interconnection of two or more CR systems (or portions of such systems) that facilitates an exchange of information, including but not limited to information relating to system access, configuration, and control (e.g., image acquisition), as well as data storage and data exchange, between any two or more CR systems or CR system components and among multiple CR systems or CR system components coupled to the network.

As should be readily appreciated, implementations of networks according to various embodiments of the present invention, suitable for interconnecting multiple CR systems or CR system components, may include any of a variety of network topologies and employ any of a variety of communication protocols. Additionally, in various networks according to the present invention, any one connection between two CR systems or CR system components may represent a dedicated connection between the two systems or components, or alternatively a non-dedicated connection which, in addition to carrying information intended for the two systems or components, may carry information not necessarily intended for either of the two CR systems or components (e.g., an open network connection). Furthermore, it should be readily appreciated that various network connections 88 of CR systems or components according to the present invention may employ one or more wireless, wire/cable, and/or fiber optic links to facilitate information transport throughout the network.

As illustrated in the embodiment of FIG. 1, each of the respective CR systems coupled to form the network includes a controller coupled to one or more CR scanners. In one embodiment, one or more controllers may be implemented as a compact desktop/personal computer (PC) or other computer system particularly programmed to implement the various functions discussed herein. Examples of computer systems suitable for purposes of the present invention include, but are not limited to, general purpose computers such as those based on Intel PENTIUM-type processors, Motorola PowerPC, Sun UltraSPARC, Hewlett-Packard PA-RISC processors, or any other type of processor. In addition to one or more of a variety of processors, controllers also may include one or more storage elements (e.g., RAM, ROM, PROM, EPROM, EEPROM, CD, DVD, optical disks, floppy disks, magnetic tape, and the like optical disks, magnetic tape, etc.) coupled to one or more processors.

In general, it should be appreciated that the respective CR system controllers shown in FIG. 1 can be implemented in numerous ways, such as with dedicated hardware (e.g., various circuitry, pre-programmed programmable logic arrays, etc.), or using one or more processors (e.g., microprocessors) that are programmed to perform the various functions discussed herein. It also should be appreciated that implementations of controllers according to various embodiments of the invention may include both hardware and software oriented elements.

In one aspect of the present invention illustrated in the embodiment of FIG. 1, the different locations in which respective networked CR systems are deployed may be significantly geographically dispersed, as in, for example, different doctors' offices, clinics, and the like. In yet another aspect, the different locations may be different rooms of the same radiography center (e.g., in a larger radiology department of a medical facility). In this aspect, each radiography room at a given radiology department or imaging center in which a CR system is deployed may be viewed as an independent entity that is coupled to one or more other independent CR systems in other rooms to form a CR network. In this manner, rather than having multiple exposure rooms of a complex facility all bringing exposed media to a central processing area to share resources, image acquisition/processing instead may be more conveniently distributed throughout the facility, thereby improving throughput, reducing traffic and media transport, etc.

According to various aspects of the invention, the distributed CR system approach significantly facilitates radiography processing methods over conventional main-frame centralized approaches. For example, in distributed CR systems according to the present invention, a radiography technician does not necessarily have to transport exposed media from a number of different exposure rooms to a centralized processing area; instead, a patient may be accepted into a service/exposure room for radiography evaluation/treatment, and a technician may remain with the patient, operate the radiography (i.e. X-ray) equipment to obtain one or more exposures, and scan the exposures to acquire images shortly thereafter in the same room/area, via a local PC-based CR system.

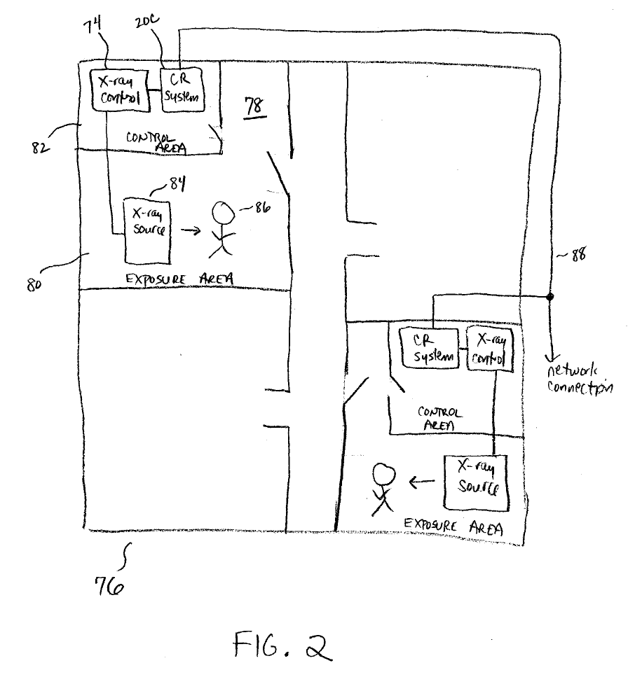

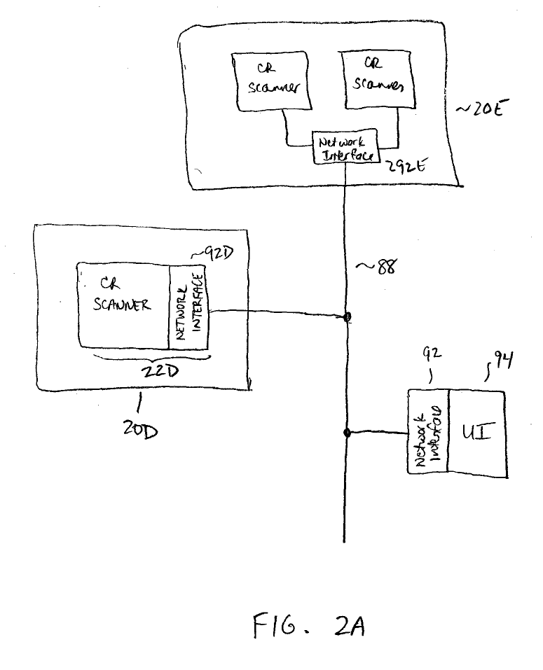

FIG. 2 is a diagram of a portion of a radiology department 76 of a medical facility in which two radiography service/exposure rooms are illustrated, according to one embodiment of the invention. As shown in the embodiment of FIG. 2, an exemplary radiography service/exposure room 78 of the radiology department 76 may include a radiation exposure area 80 (e.g., including an X-ray tube or source 84) and a protected control area 82 (e.g., a small office partitioned off from the radiation exposure area 80). Located in the protected control area 82 are X-ray control devices/equipment 74 and a PC-based CR system 20C, coupled via the network connection 88 to a distributed CR network (for illustrative purposes, the X-ray control 74 and CR system 20C also are shown in the distributed CR network of FIG. 1).

In an image acquisition method according to one embodiment of the invention, with reference to FIG. 2, a patient 86 is brought into the exposure area 80 and positioned for an exposure by a technician. The technician then goes to the nearby protected control area 82 to enter patient information into the PC-based CR system 20C, and controls the X-ray source 84 via the control device/equipment 74 so as to radiate the patient and obtain an exposure. After each exposure, the exposed media may be placed by the technician into a CR scanner of the PC-based CR system 20C for scanning and image acquisition.

Between each exposure of a multiple exposure evaluation/treatment, the PC-based CR system can be scanning and acquiring images from a previous exposure while the technician positions the patient for a subsequent exposure. Once the images are scanned and acquired by the PC-based CR system, and identifiable by information entered by the technician (e.g., patient information, some other identifier or code, etc.), the stored digitized images may be transported and/or accessed throughout the network, as well as archived for future use.

In particular, with reference again to FIG. 1, files of one or more digitized images may be archived at any one or more of the CR systems coupled to the network (e.g., see the archive 70 of the CR system 20A), in a central “stand alone” archive coupled to the network (as shown for example by the archive 72 in FIG. 1), and/or in one or more distributed archives coupled to the network, for example. It should be appreciated that a number of archiving techniques may be employed in various embodiments of the present invention, and that the foregoing examples are provided for purposes of illustration only.

In another aspect of the invention as illustrated by the embodiments of FIGS. 1 and 2, the process of patient-image identification is simplified over conventional centralized radiography processing methods. For example, cassettes equipped with some memory mechanism (e.g., memory chips) to enable image identification are not necessarily required (although optionally they may be employed). More specifically, as shown in the embodiment of FIG. 2, since a single patient may be exposed and the exposed image recording media scanned or read in the same area, the technician themselves may open a pre-defined patient file in the CR system, enter any appropriate identification information, and direct the patient's acquired image data to be stored in the file. Accordingly, in one aspect of the present invention, cassettes for holding the image recording media may be more simply designed than those cassettes used in conventional centralized processing approaches.

In yet another aspect of the embodiments shown in FIGS. 1 and 2, the overall workflow process is simplified over conventional centralized radiography processing methods; namely, there is no need to cross reference/track several cassettes and image recording media of different sizes during centralized processing by a main frame CR system. Additionally, X-ray analysis may be expedited according to the embodiments discussed above, as a technician may verify the quality of a scanned image immediately after image acquisition by the PC-based CR system.

Additionally, in yet another aspect, with reference again to FIG. 1, image files may be shared between and among multiple CR systems of the network (e.g., the systems 20A, 20B, and 20C), stored/archived in any one or more of the CR systems (e.g., the archive 70 of the CR system 20A), sent via the network to a central archive 72 or multiple distributed archives, etc. In yet another aspect, this image storing/archiving process can be done in parallel for each PC-based CR system of the network. In particular, in one aspect, CR systems at different locations processing different images of a same patient may transmit various image-related information to a common patient file in an archive. Once archived, system users (e.g., doctors, dentists, other medical professionals, technicians, analysts, etc.) coupled to the network via a user terminal/diagnostic workstation 90 at various locations can retrieve images at will to their diagnostic workstations for analysis, and again refer to stored images in the future if necessary.

In yet another aspect, with reference again to FIG. 2, because a PC-based CR system may be conveniently located in an X-ray control area of a service/exposure room, the CR system also may be connected to the X-ray control equipment (as indicated by the connection between the equipment 74 and the CR system 20C). If the CR system in turn is coupled to one or more other CR systems via the network connection 88 as discussed above, various exposure data (e.g., KV and mAs including anatomic programming data) associated with acquired images may be transferred throughout the network. For example, in one aspect, exposure data optionally may be included or appended to patient identification data or other identifiers associated with one or more scanned images stored in a patient file. FIG. 1 also illustrates an example of such an arrangement, in which the controller of the CR system 20C is coupled to X-ray control device/equipment 74.

In yet other aspects of the foregoing embodiment, a distributed CR system architecture enables custom X-ray room design and development, including matching various specifications of an X-ray system with a CR system based on exposure needs, matching cassettes sizes and software packages to the specific medical application performed at the specific room, etc. Additionally, a distributed CR system architecture also provides economical benefits, enabling system implementation and development on a room by room basis and stretching out such an investment over time, rather than requiring a significant initial investment in a large main-frame based processing center.

The various functions discussed above in connection with the distributed CR system embodiments of FIGS. 1 and 2 may be distributed among one or more CR systems or other computer systems coupled to the network via the network connection 88, or duplicated on any two or more CR systems or other computer systems coupled to the network. In particular, in one aspect, the distributed CR systems may be implemented using a client/server arrangement, in which one or more CR systems or other computer systems are configured to provide a service (e.g., servers) to one or more client CR systems or other computer systems. For example, in one embodiment, the archive 72 shown in FIG. 1 may be implemented as a server that provides archiving services to one or more CR system clients coupled to the network. In yet another embodiment, any one of the CR systems coupled to the network may be configured as a server for one or more other client CR systems coupled to the network, wherein the server CR system includes an archive (e.g., as illustrated in FIG. 1 by the system 20A including the archive 70).

Additionally, in yet another embodiment, the various functions discussed above in connection with FIGS. 1 and 2 may be accomplished via another exemplary implementation shown in FIG. 2A. In this implementation, one or more CR systems 20D and 20E may include one or more CR scanners coupled to the network connection 88 via one or more network interface devices 92D and 92E (rather than being coupled to the network connection via a PC-based controller as in FIG. 1). In one aspect of this embodiment, as illustrated by the CR system 20D, a CR scanner 22D may be configured as an integrated device together with a network interface 92D.

In another aspect of this embodiment, the network interface devices themselves may not be configured with a user interface, but rather merely are configured to facilitate communication between one or more CR scanners and the network. A user may gain access to the network so as to control one or more CR scanners and/or retrieve various information therefrom via one or more user interfaces 94 similarly coupled to the network connection 88 via one or more respective network interface devices 92. In yet another aspect of this embodiment, one or more such user interfaces may be a PC-based controller as discussed above in connection with FIG. 1. The implementation of FIG. 2A differs from that shown in FIG. 1, however, in that one or more CR systems may include one or more CR scanners that are coupled to the network without using a PC-based or other controller/user interface local to the scanner(s).

Redundant CR Systems and Methods

Applicants have also recognized various benefits of employing multiple CR scanners at a single location to achieve improved image acquisition throughput and robustness. Accordingly, in one embodiment of the present invention (as shown for example in FIG. 1 by the CR systems 20A and 20B), multiple CR scanners at one location may be coupled to and independently controlled by a single controller device. As discussed above, the controller device may be, for example, a general purpose or specific purpose desktop computer (PC) to which multiple CR scanners are coupled by, for example, cable or wireless connections. It should be appreciated that the concept of CR scanner redundancy at a given location, according to one embodiment of the present invention, is not limited to implementations involving multiple PC-based CR systems connected via a network, and may be implemented, for example, in a stand-alone PC-based CR system involving multiple scanners.

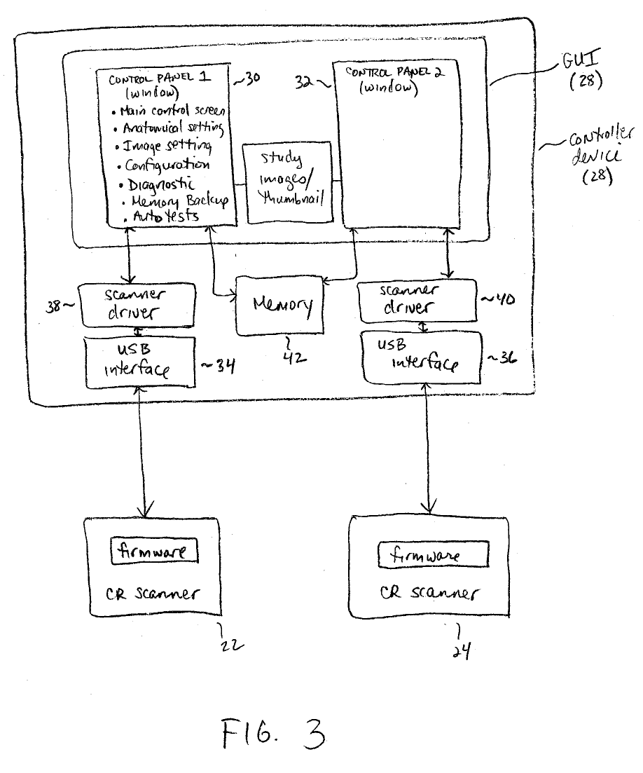

FIG. 3 illustrates a redundant computed radiography (CR) system (based on the system 20B shown in FIG. 1) according to one embodiment of the invention. In the embodiment of FIG. 3, two CR scanners 22 and 24 are coupled to a controller device 26 via conventional Universal Serial Bus (USB) interfaces 34 and 36. According to one aspect of this embodiment, when each CR scanner is first coupled to the controller device 26, the CR scanner and the controller device engage in a handshake protocol implemented by a scanner driver 38, 40. The handshake protocol enables the controller device to identify each CR scanner and assign to each CR scanner one or more identifiers (e.g., a device number, address, etc.) which facilitates subsequent identification of and communication with the CR scanners. The controller device also may assign each CR scanner memory space in a shared memory 42 for storage of digital image information and/or other operational parameters associated with each CR scanner.

In general, for each CR scanner of the system shown in FIG. 3, the controller device 26 is configured to install a proprietary scanner driver and a USB interface driver that allows the communication of digital image information, control messages, error messages, etc., between each CR scanner and the controller device. Other set-up parameters related to the CR scanner may be loaded at the time of initial coupling.

According to one aspect of this embodiment, as discussed above, the controller device 26 is configured such that multiple CR scanners coupled to the controller device 26 may be controlled independently of each other. In particular, multiple CR scanners in the redundant system shown in FIG. 3 may scan exposed media of the same patient essentially simultaneously, and each scanner may exchange information with the controller device 26 independently of the activity of one or more other CR scanners. Additionally, multiple CR scanners of the redundant system shown in FIG. 3 may scan exposed media relating to the same or different patient at a given time. In general, according to one embodiment, the controller device 26 is configured such that an operator is able to control multiple CR scanners in parallel to obtain digital image information at an increased speed, hence increasing overall image acquisition throughput.

According to another aspect of the embodiment shown in FIG. 3, the controller device 26 is configured such that CR scanners may be coupled to or disconnected from the controller device at any time without interruption of image acquisition processes being carried out by one or more other CR scanners coupled to the controller device. In particular, when an additional CR scanner is coupled to the controller device, the process of handshaking and set-up as discussed above may be performed on a scanner-by-scanner basis.

Similarly, in another aspect, if one of the CR scanners in the redundant system of FIG. 3 malfunctions, one or more other CR scanners will continue to operate. In particular, the controller device 26 may be configured to actively scan for, and recognize, a malfunctioning CR scanner and take it off-line to conserve processor power and indicate to an operator that the malfunctioning scanner should not be used and should be serviced (e.g., the controller device may be configured to notify the operator of the malfunctioning CR scanner via an error message). As a result, a malfunctioning CR scanner may be repaired or replaced without significantly impacting the overall operation of the CR system, thereby increasing system reliability and robustness.

According to another aspect of the embodiment shown in FIG. 3, the controller device 26 is configured to coordinate the activities of multiple CR scanners in the redundant system. For example, the controller device 26 may allocate space in memory 42 for each CR scanner to store the digital image data it acquires. In one aspect, memory allocated in a given controller device may serve as an archive for acquired image data for all scanners coupled to the device (and optionally other controller devices if the redundant CR system is coupled to a network, as shown for example in FIG. 1).

In particular, in one aspect, the controller device 26 shown in FIG. 3 may receive all the digital image information relating to a single patient from the redundant CR scanners 22 and 24, consolidate the digital image information into a single patient file, or “study,” and either store the study in a local archive (e.g., a portion of memory 42) and/or optionally transmit the file to an archive at another location for possible retrieval and display at other locations (e.g., see FIG. 1). In yet another aspect of the invention, the controller device may not necessarily first consolidate into a single file or study digital image information relating to the same patient acquired from different scanners, but may instead transmit in a stream to an archive (e.g., a remote archive or CR system at another location as shown in FIG. 1) the digital image information as it is acquired from multiple scanners. In this aspect, image acquisition latency may be decreased, as it allows remote access to and display of scanned images shortly after they are scanned, rather than requiring an operator to wait until all the exposed media relating to a patient have been scanned and consolidated by the controller device 26.

In another aspect of a controller device 26 shown in the embodiment of FIG. 3, one or more user interfaces (e.g., a graphical user interface (GUI) 28) facilitate the interaction of an operator with the multiple CR scanners 22 and 24. For example, one or more GUIs 28 may provide the operator with one or more control panels 30, 32 for each of the CR scanners coupled to the controller device 26. Using the control panels 30, 32, the operator may perform a variety of functions in connection with the scanners 22 and 24, including, but not limited to, set-up, image acquisition and processing, diagnostics and image verification.

In particular, one or more user interfaces 28 may be established on the controller device 26 to allow an operator to adjust parameters of one or more CR scanners, perform CR scanner diagnostics, verify digital image quality, and perform other CR scanner control functions via the controller device. According to one aspect, the interface 28 may allow an operator to perform functions related to CR scanner 22 while CR scanner 24 continues to send digital image information to the controller device 26. Furthermore, the digital image information acquired from CR scanner 24 may continue to be displayed on the interface 28 while the operator is performing functions related to CR scanner 22. As discussed further below, each control panel may be implemented in the form of a window that is activated to allow the operator to interface with the CR scanner to which the window is related (e.g., using a conventional point and click scheme on a PC), while the window related to the other CR scanner is deactivated and its functions execute in the background.

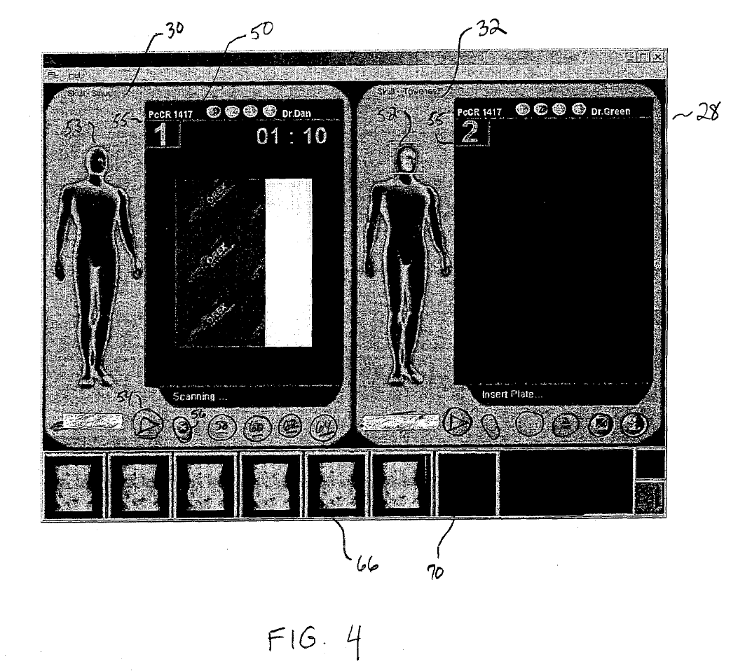

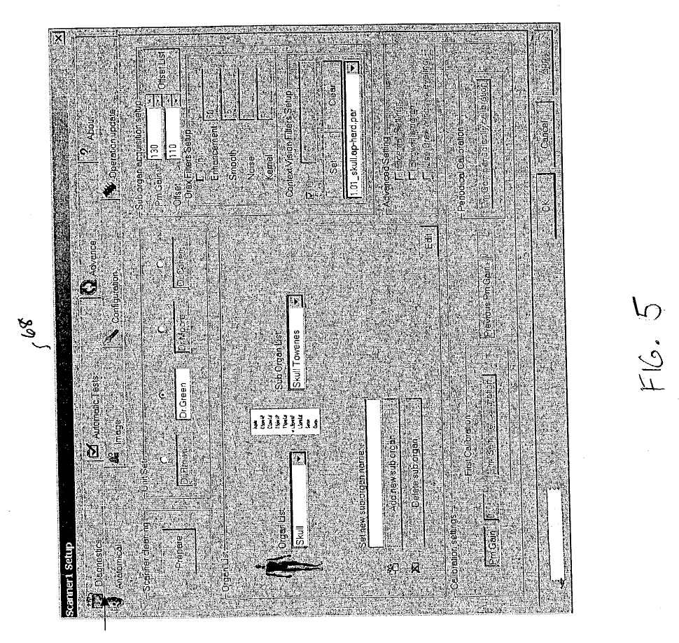

FIG. 4 illustrates an exemplary graphic user interface (GUI) 28 of the redundant CR system of FIG. 2, according to one embodiment of the invention. In FIG. 4, a first control panel 30 is shown corresponding to one of the scanners 22 and 24, while a second control panel 32 is shown for the other of the scanners 22 and 24. Each of the control panels 30 and 32 shown in FIG. 4 includes a representation 53 of a patient (scanning subject) and an image viewing window 55. In one aspect of this embodiment, the image viewing window 55 may include a configuration bar 50 which facilitates the selection of one of four predefined scanner configurations for the scanner represented by a given control panel (discussed further below in connection with FIG. 5). As shown for example in the control panel 32, each control panel also may include an organ window 52, superimposed on the patient representation 53, to indicate a particular portion of a patient which the scanner represented by a given control panel is configured to scan, based on the selected predefined scanner configuration.

As shown in the embodiment of FIG. 4, each control panel 30 and 32 also may include a series of function buttons (e.g., located at the bottom portion of each control panel in FIG. 4), as illustrated by the buttons 54, 56, 58, 60, 62, and 64 of the control panel 30. In one aspect, the controller device 26 may be configured such that an operator may use different buttons in the GUI control panels to accomplish various functions in connection with the scanning process associated with each scanner. For example, in the control panel 30, the button 54 may be used by an operator to initiate an image media scan by the scanner associated with the control panel 30. Similarly, the button 56 may be used to abort a scan, the button 58 may be used to erase a plate upon completion of image acquisition, the button 60 may be used to eject a plate from the scanner, the button 62 may be used to setup the scanner (e.g., establish predefined scanner configurations as discussed further below in connection with FIG. 5), and the button 64 may be used to end or exit a scanning session. It should be appreciated that the location of the function buttons shown in FIG. 4, as well as the assignment of particular buttons to particular functions as discussed above, is for purposes of illustration only, and that the invention is not limited in this respect.

As also shown in FIG. 4, the GUI 28 may include a preview panel or bar 66 which displays scanned images from a selected scanner essentially in real time as the images are scanned sequentially. In FIG. 4, the empty preview pane 70 of the bar 66 indicates an image currently being scanned but not yet complete. According to one aspect of this embodiment, the control device 26 may be configured such that an operator may “click” on a particular preview pane of the bar 66 and enlarge a particular pane for more detailed viewing. Once a particular scanning session is completed, the images scanned into a study may be displayed in the image viewing window 55 of a given control panel.

FIG. 5 illustrates an exemplary set-up panel 68 associated with the GUI 28 of FIG. 4, according to one embodiment of the invention. In particular, according to one aspect of this embodiment, the set-up panel 68 of FIG. 5 is made available to an operator via the GUI 28 when the operator uses the setup function button 62 discussed above in connection with FIG. 3. As illustrated in FIG. 5, the set-up panel 68 enables an operator to define four different configurations for each scanner that later may be recalled by a user via the configuration bar 50 shown in FIG. 4. For each predefined configuration, an operator may set a number of parameters relating to the operation of a scanner and the nature of the images to be scanned, including, but not limited to, scanner diagnostic, test, and calibration parameters, image filtering and enhancement parameters, anatomical parameters, and the like.

Redundant CR systems similar to those described above in connection with FIGS. 3, 4, and 5 may be employed in a radiology service/exposure room, for example. With reference again to FIG. 2, in an image acquisition method according to one embodiment of the invention, a patient is brought into the exposure area and positioned by a technician to be exposed by radiation for a “study” (a collection of multiple images of one or more body areas). The technician then goes to the nearby protected control area to enter patient information into the controller device, and controls the X-ray equipment so as to radiate the patient and obtain an exposure. After each exposure, the exposed media may be placed by the technician into one of the CR scanners in the redundant system for scanning and image acquisition. Between each exposure of a multiple exposure evaluation/treatment, a given CR scanner can be scanning and acquiring images from a previous exposure while the technician positions the patient for a subsequent to exposure. If the technician is acquiring exposed media faster than a single CR scanner can process them, one or more other CR scanners in the redundant system can be employed for scanning exposed media to improve image acquisition throughput.

Of course, it should be appreciated that a redundant CR system in accordance with the present invention is not limited to two CR scanners as shown in the embodiment of FIG. 3 (e.g., see system 20A of FIG. 1). Rather, a redundant CR system according to the present invention can be scaled to utilize any number of independently functioning CR scanners interfacing with a controller device as a redundant array of scanners, based on the concepts discussed herein.

It should be appreciated that the various functions outlined herein in connection with both distributed and redundant CR systems, as performed individually or in combination by the various controllers/control devices discussed herein (e.g., desktop/personal computers, other types of processors, etc.), may be defined by computer-readable signals tangibly embodied on a computer-readable medium (or multiple computer readable media). Such signals may define instructions, for example, as part of one or more programs, that, as a result of being executed by one or more controllers, instruct the controller(s) to perform one or more of the functions discussed herein. Such programs may be coded as software that is executable on one or more processors employing any one of a variety of operating systems or platforms. Additionally, such software may be written using any of a number of suitable programming languages and/or conventional programming or scripting tools, and also may be compiled as executable machine language code.

In this respect, it should be appreciated that one embodiment of the invention is directed to a computer readable medium (or multiple computer readable media) (e.g., various types of storage elements such as computer memory, one or more floppy discs, compact discs, optical discs, magnetic tapes, etc.) encoded with one or more programs that, when executed on one or more controllers or other processors, perform methods that implement the various embodiments of the invention discussed above. The computer readable medium or media can be transportable, such that the program or programs stored thereon can be loaded onto one or more different controllers or other processors to implement various aspects of the present invention as discussed above. It should be understood that the term “program” is used herein in a generic sense to refer to any type of computer code that can be employed to program a controller (e.g., computer) or other processor to implement various aspects of the present invention as discussed above. Additionally, it should be appreciated that according to one aspect of this embodiment, one or more computer programs that when executed perform methods of the present invention need not reside on a single controller or processor, but may be distributed in a modular fashion amongst a number of different controllers or processors to implement various aspects of the present invention.

Having thus described at least one illustrative embodiment of the invention, various alterations, modifications, and improvements will readily occur to those skilled in the art. Such alterations, modifications, and improvements are intended to be within the spirit and scope of the invention. While some examples presented herein involve specific combinations of functions or structural elements, it should be understood that those functions and elements may be combined in other ways according to the present invention to accomplish the same or different objectives. In particular, acts, elements and features discussed in connection with one embodiment are not intended to be excluded from a similar role in other embodiments. Accordingly, the foregoing description is by way of example only, and is not intended as limiting.

Use of ordinal terms such as “first,” “second,” “third,” etc., in the claims to modify a claim element does not by itself connote any priority, precedence, or order of one claim element over another or the temporal order in which acts of a method are performed. Rather, these terms are used merely as labels to distinguish one claim element having a certain name from another element having a same name (but for use of the ordinal term) to distinguish the claim elements.

What is claimed is:

1. In a first computed radiography (CR) system including at least one radiation scanning apparatus configured to acquire first images from exposed image recording media, an apparatus comprising:
at least one first controller configured to facilitate at least one of transmitting first information relating to the acquired first images to at least one second CR system and receiving second information relating to second images acquired by the at least one second CR system.

2. The apparatus of claim 1, wherein the at least one first controller is configured to transmit the first information or receive the second information via an open network connection.

3. The apparatus of claim 1, wherein:
the at least one first controller includes at least one storage element;
the at least one storage element is configured to include at least one archive to store image information; and
the at least one first controller is configured to store at least one of the first information and the received second information in the at least one archive.

4. The apparatus of claim 3, wherein the at least one first controller is configured to transmit image information stored in the at least one archive via an open network connection.

5. The apparatus of claim 3, wherein the at least one first controller is configured to receive the second information and store the received second information in the at least one archive.

6. The apparatus of claim 5, wherein:
the at least one archive includes at least one first patient file;
both the first information and the received second information relate to a same patient; and
the at least one first controller is configured to store both the first information and the received second information in the at least one first patient file.

7. The apparatus of claim 5, wherein the at least one first controller is configured to transmit image information stored in the at least one archive via an open network connection.

8. The apparatus of claim 1, in combination with the at least one radiation scanning apparatus such that the at least one first controller forms part of the first CR system, wherein the at least one first controller further is configured to control the at least one radiation scanning apparatus so as to acquire the first images.

9. The combination of claim 8, wherein the at least one radiation scanning apparatus includes at least two radiation scanning apparatus each configured to acquire the first images from exposed image recording media.

10. The combination of claim 9, wherein each of the at least two radiation scanning apparatus is coupled to the at least one first controller.

11. The combination of claim 8, wherein the at least one first controller is configured to be coupled to at least one X-ray control device used to expose the exposed image recording media so as to obtain exposure data associated with the acquired first images.

12. The combination of claim 11, further including the at least one X-ray control device.

13. The combination of claim 11, wherein the at least one first controller further is configured to transmit the obtained exposure data via an open network connection.

14. The combination of claim 13, wherein the at least one first controller further is configured to transmit via the open network connection the first information relating to the acquired first images together with the obtained exposure data.

15. In a first computed radiography (CR) system including at least one radiation scanning apparatus configured to acquire first images from exposed image recording media, an apparatus comprising:
at least one first controller configured to transmit first information relating to the acquired first images to at least one archive, the at least one archive being configured to receive second information relating to second images acquired by at least one second CR system.

16. In a first computed radiography (CR) system in which first images are acquired from exposed image recording media, a method comprising an act of:
A) transmitting first information relating to the acquired first images to at least one second CR system.

17. In a first computed radiography (CR) system in which first images are acquired from exposed image recording media and first information is obtained relating to the first acquired images, a method comprising an act of:
A) receiving second information relating to second images acquired by at least one second CR system.

18. In a first computed radiography (CR) system in which first images are acquired from exposed image recording media, a method comprising an act of:
A) transmitting first information relating to the acquired first images to at least one archive, the at least one archive being configured to receive second information relating to second images acquired by at least one second CR system.

19. At least one computer readable medium having computer-readable signals stored thereon that define instructions which, as a result of being executed by at least one processor, instruct the at least one processor to perform a method in a first computed radiography (CR) system in which first images are acquired from exposed image recording media, the method comprising an act of:
A) transmitting first information relating to the acquired first images to at least one second CR system.

20. At least one computer readable medium having computer-readable signals stored thereon that define instructions which, as a result of being executed by at least one processor, instruct the at least one processor to perform a method in a first computed radiography (CR) system in which first images are acquired from exposed image recording media, the method comprising an act of:
A) receiving second information relating to second images acquired by at least one second CR system.

21. At least one computer readable medium having computer-readable signals stored thereon that define instructions which, as a result of being executed by at least one processor, instruct the at least one processor to perform a method in a first computed radiography (CR) system in which first images are acquired from exposed image recording media, the method comprising an act of:
A) transmitting first information relating to the acquired first images to at least one archive, the at least one archive being configured to receive second information relating to second images acquired by at least one second CR system.

22. A distributed computed radiography (CR) system, comprising:
a first CR system; and
at least one second CR system coupled to the first CR system via a network,
wherein each CR system comprises:
at least one controller coupled to the network; and
at least one radiation scanning apparatus coupled to the at least one controller and configured to acquire images from exposed image recording media.

23. The system of claim 22, wherein the at least one controller is configured to transport data relating to the acquired images via the network.

24. The system of claim 22, wherein at least one controller of at least one of the first CR system and the at least one second CR system includes a desktop personal computer (PC) coupled to at least one radiation scanning apparatus.

25. The system of claim 24, wherein each of the first CR system and the at least one second CR system is a PC-based CR system.

26. The system of claim 22, further comprising:
at least one archive coupled to the network to store acquired image data.

27. The system of claim 26, wherein at least one controller of at least one of the first CR system and the at least one second CR system includes at least one archive to store acquired image data.

28. The system of claim 26, wherein the first CR system and the at least one second CR system are configured to transport respective acquired image data relating to a same patient to the at least one archive, and wherein the at least one archive is configured to store the respective acquired image data in a single patient file.

29. The system of claim 22, wherein at least one of the first CR system and the at least one second CR system includes at least two radiation scanning apparatus each configured to acquire images from exposed image recording media.

30. The system of claim 29, wherein the at least two radiation scanning apparatus are coupled to a same controller of the at least one CR system.

31. The system of claim 30, wherein the same controller includes a desktop personal computer.

32. The system of claim 22, wherein at least one of the first CR system and the at least one second CR system is configured to be coupled to at least one X-ray control device used to expose the exposed image recording media so as to obtain exposure data associated with the exposed image recording media.

33. The system of claim 32, in combination with the at least one X-ray control device.

34. The system of claim 32, wherein the at least one of the first CR system and the at least one second CR system that is configured to be coupled to at least one X-ray control device so as to obtain exposure data associated with the exposed image recording media also is configured to transport the obtained exposure data via the network.

35. The system of claim 34, wherein the at least one controller is configured to transport data relating to the acquired images via the network.

36. The system of claim 35, wherein the at least one controller is configured to transport via the network the data relating to the acquired images together with the obtained exposure data.

37. A radiography method, comprising acts of:
(a) acquiring first image data at a first location;
(b) transporting the acquired first image data from the first location to an archive;
(c) acquiring second image data at a second location different from the first location; and
(d) transporting the acquired second image data from the second location to the archive.

38. The method of claim 37, wherein the act (b) comprises an act of:
transporting the acquired first image data from the first location over an open network connection to the archive.

39. The method of claim 38, wherein the act (d) includes an act of:
transporting the acquired second image data from the second location over the open network connection to the archive.

40. The method of claim 37, wherein the first image data and the second image data relate to a same patient, and wherein the method further includes an act of:
storing both the first image data and the second image data in at least one file associated with the patient.

41. The method of claim 37, wherein:
the act (a) includes an act of acquiring the first image data and first exposure data related to the first image data at the first location; and
the act (b) includes an act of transporting the acquired first image data together with first exposure data from the first location to the archive.

42. The method of claim 41, wherein:
the act (c) includes an act of acquiring the second image data and second exposure data related to the second image data at the second location; and
the act (d) includes an act of transporting the acquired second image data together with second exposure data from the second location to the archive.

43. The method of claim 37, wherein the act (a) includes an act of:
acquiring the first image data at the first location using at least two radiation scanning apparatus configured to acquire images from exposed image recording media.

44. The method of claim 43, wherein the at least two radiation scanning apparatus are coupled to a same controller to acquire the first image data, and wherein the act (b) includes an act of:
(b1) transporting the acquired first image data from the same controller to the archive.

45. The method of claim 44, wherein the act (b1) includes an act of:
transporting the acquired first image data from the same controller over an open network connection to the archive.

46. A radiology department of a medical facility, comprising:
a first radiation exposure area including a first control area, the first control area including at least one first PC-based computed radiography (CR) system configured to scan and acquire images from image recording media that are exposed in the first radiation exposure area; and
a second radiation exposure area including a second control area, the second control area including at least one second PC-based CR system configured to scan and acquire images from image recording media that are exposed in the second radiation exposure area, wherein the at least one first PC-based CR system and the at least one second PC-based CR system are coupled to a same network.

47. A radiography method in a radiology department of a medical facility, comprising acts of:
(a) reading at least one first exposed image recording medium in a first area of the radiology department to acquire first image data;
(b) transporting the acquired first image data from the first area to an archive;
(c) reading a second exposed image recording medium in a second area of the radiology department different from the first area to acquire second image data;
(d) transporting the acquired second image data from the second area to the, archive.

48. The method of claim 47, wherein the act (b) includes an act of:
transporting the acquired first image data from the first area over an open network connection to the archive.

49. The method of claim 48, wherein the act (d) includes an act of:
transporting the acquired second image data from the second area over the open network connection to the archive.

50. The method of claim 47, wherein the at least one first exposed image recording medium includes at least two exposed image recording media, and wherein the act (a) includes an act of:
simultaneously reading the at least two exposed image recording media in the first area of the radiology department to acquire the first image data.

51. A computed radiography (CR) system, comprising:
at least two radiation scanning apparatus configured to acquire images from exposed image recording media; and
a controller coupled to the at least two radiation scanning apparatus and configured to control the at least two radiation scanning apparatus so as to acquire the images from the exposed image recording media.

52. The system of claim 51, wherein the controller includes a desktop personal computer (PC).

53. The system of claim 51, wherein the controller is configured to independently control the at least two radiation scanning apparatus.

54. The system of claim 51, wherein the controller is configured to simultaneously acquire images from different radiation scanning apparatus of the at least two radiation scanning apparatus.

55. The system of claim 51, wherein the controller is configured to independently control the at least two radiation scanning apparatus and simultaneously acquire images from different radiation scanning apparatus of the at least two radiation scanning apparatus.

56. The system of claim 51, wherein the controller includes at least one storage element configured to store at least one data file, and wherein the controller is configured to store images acquired from different radiation scanning apparatus of the at least two radiation scanning apparatus to a same data file.

57. The system of claim 51, wherein the controller is configured to continue controlling at least one radiation scanning apparatus notwithstanding a non-responsiveness of another radiation scanning apparatus.

58. The system of claim 51, wherein the controller includes a Universal Standard Bus (USB) interface for each radiation scanning apparatus coupled to the controller.

59. The system of claim 51, wherein the controller is configured to support at least one user interface to facilitate control of the at least two radiation scanning apparatus.

60. The system of claim 59, wherein the at least one user interface includes at least one graphics user interface (GUI).

61. The system of claim 60, wherein the at least one GUI includes at least one control panel for each radiation scanning apparatus of the at least two radiation scanning apparatus.

62. The system of claim 60, wherein the at least one GUI includes at least one display to facilitate viewing of the acquired images.

63. The system of claim 62, wherein the at least one display is configured to display images acquired from different radiation scanning apparatus of the at least two radiation scanning apparatus.

64. An emergency room of a medical facility, comprising:
a first radiation exposure area including a first control area, the first control area including at least one PC-based computed radiography (CR) system configured to scan and acquire images from image recording media that are exposed in the first radiation exposure area, wherein the at least one PC-based CR system includes:
at least two radiation scanning apparatus configured to acquire the images from the exposed image recording media; and
a controller coupled to the at least two radiation scanning apparatus and configured to control the at least two radiation scanning apparatus so as to acquire the images from the exposed image recording media.

65. A radiography method, comprising acts of:
(a) acquiring first image data at a first location using a first device;
(b) acquiring at least second image data at the first location using at least one second device; and
(c) transporting the acquired first image data and at least the second image data from the respective first and second devices to a same data processor.

66. A radiography control method, comprising an act of:
controlling at least two radiation scanning apparatus configured to acquire images from exposed image recording media using a single controller.

67. At least one computer readable medium having computer-readable signals stored thereon that define instructions which, as a result of being executed by a single computer, instruct the single computer to perform a radiography control method comprising an act of:
controlling at least two radiation scanning apparatus configured to acquire images from exposed image recording media using the single computer.
